(19) United States
(12) Patent Application Publication
(10) Pub. No.: US 2010/0247978 A1
(43) Pub. Date: Sep. 30, 2010

(54) METHOD OF MANUFACTURING A SUBSTRATE FOR A MAGNETIC DISK

(75) Inventors: Junpei Fukada, Tokyo (JP); Takanori Mizuno, Tokyo (JP); Hiroshi Tsuchiya, Tokyo (JP)

Correspondence Address: AMSTER, ROTHSTEIN & EBENSTEIN LLP, 90 PARK AVENUE, NEW YORK, NY, 10016, US

(73) Assignee: HOYA CORPORATION, Tokyo (JP)

(21) Appl. No.: 12/749,021

(22) Filed: Mar. 29, 2010

(30) Foreign Application Priority Data
Mar. 30, 2009 (JP) 2009-081698
Dec. 24, 2009 (JP) 2009-292228

(51) Int. Cl. G11B 7/252; B24B 1/00

(52) U.S. Cl. 428/848; 451/63

(57) ABSTRACT

A magnetic disk substrate manufacturing method of this invention includes a main surface polishing process that polishes disk-shaped glass substrates by the use of a polishing machine having a carrier pressed between a pair of polishing surface plates and adapted to make an orbital motion while rotating on its axis in a state of holding the disk-shaped glass substrates. In the polishing machine, the carrier is placed in a state where a plate-like member is disposed on one side of main surfaces of the disk-shaped glass substrate, so that only the other side of the main surfaces of the disk-shaped glass substrate is polished while allowing the one side of the main surfaces of the disk-shaped glass substrates to be a non-polishing main surface.

### CROSS REFERENCE TO RELATED APPLICATIONS

This application claims the benefit of priority from Japanese Patent Application No. 2009-081698, filed on Mar. 30, 2009, and Japanese Patent Application No. 2009-292228, filed on Dec. 24, 2009, the disclosures of which are incorporated herein in their entirety by reference.

### TECHNICAL FIELD

This invention relates to a method of manufacturing a substrate for a magnetic disk for use in a magnetic disk device such as a hard disk drive (HDD). Hereinafter, a substrate for a magnetic disk may also be referred to as a magnetic disk substrate.

### BACKGROUND

Currently, a magnetic disk having a magnetic layer formed on each of main surfaces of a disk-shaped substrate is widely used in a hard disk drive. Such a disk is manufactured through shaping (coring, chamfering, etc.), lapping, and polishing (end faces and main surfaces).

In a main surface polishing process of a magnetic disk substrate manufacturing method, a carrier holding disk-shaped substrates is placed between a pair of surface plates (upper and lower surface plates), then the carrier is pressed between the upper and lower surface plates, and then the upper and lower surface plates are rotated in opposite directions to each other, thereby polishing both main surfaces of the disk-shaped substrates while supplying a polishing agent (see, e.g. JP-A-2007-90452).

The recording density of a magnetic disk has been increasing year by year and even a magnetic disk having a recording capacity of 100GB or more on its one side has been developed. Currently, the magnetic disk satisfies a required recording capacity as the sum of recording capacities on both sides thereof. However, if the recording density increases in this manner, the required recording capacity will be satisfied only on one side of a magnetic disk particularly in the case of an electronic device that does not require a so large recording capacity. If the required recording capacity is satisfied only on one side of the magnetic disk as described above, the number of components can be reduced on the HDD side such that a single magnetic head is sufficient for one magnetic disk. This is advantageous in terms of cost and further makes it possible to achieve a reduction in thickness of the HDD. Therefore, it is expected that there will be an increasing need for a magnetic disk having a magnetic layer only on one side thereof. Consequently, there is required a substrate for such a magnetic disk having the magnetic layer only on its one side, i.e. a substrate adapted to use only one of its main surfaces as the main surface for use in magnetic recording.

### SUMMARY OF THE INVENTION

In the case of manufacturing the substrate for the magnetic disk having the magnetic layer only on its one side, a main surface of the substrate to be provided with no magnetic layer (a non-recording surface) does not require a surface quality such as a quality of roughness as high as that required for a magnetic recording surface and therefore it is considered that polishing, particularly final polishing, of the substrate on its non-recording surface side may not often be required actually.

However, in the conventional polishing of a substrate, a machine designed to simultaneously polish both main surfaces thereof is predominant and this demand will never stop. Therefore, in the manufacture of a substrate for a magnetic disk, if it is possible to polish only one of main surfaces of the substrate so as to provide a magnetic recording surface only on its one side by the use of the machine designed to simultaneously polish both main surfaces thereof, it is possible to prevent the occurrence of particles (foreign matter) on a non-recording surface, which would otherwise originate from polishing abrasive particles in a polishing process.

This invention has been made in view of the above and has an object to provide a magnetic disk substrate manufacturing method capable of efficiently processing a substrate for a magnetic disk having a magnetic layer only on its one side.

According to one aspect of this invention, there is provided a magnetic disk substrate manufacturing method, comprising: a main surface polishing step of polishing disk-shaped substrates by the use of a polishing machine having a carrier pressed between a pair of surface plates and adapted to make an orbital motion while rotating on its axis, the carrier holding the disk-shaped substrates, wherein, in the polishing machine, the carrier is placed in a state where a plate-like member is disposed on one side of main surfaces of the disk-shaped substrate, so that only the other side of the main surfaces of the disk-shaped substrate is polished while allowing the one side of the main surfaces of the disk-shaped substrates to be a non-polishing main surface.

According to another aspect of this invention, there is provided a magnetic disk substrate manufacturing method, comprising: a main surface polishing step of polishing disk-shaped substrates by the use of a polishing machine having carriers pressed between a pair of surface plates and adapted to make an orbital motion while rotating on their axes, the carriers holding the disk-shaped substrates, wherein, in the polishing machine, in a state where the carriers are respectively placed on both sides of a plate-like member so that the plate-like member is disposed on one side of main surfaces of the disk-shaped substrate held in one of the carriers and on one side of main surfaces of the disk-shaped substrate held in the other carrier, only the other sides of the main surfaces of the disk-shaped substrates are polished while allowing one sides of the main surfaces of the disk-shaped substrates held in the carriers to be a non-polishing main surface.

According to each of these methods, since only one of main surfaces of each of substrates can be polished even by using a double-side polishing machine, the substrates for one-side magnetic recording can be efficiently produced. Further, in the manufacture of magnetic disk substrates, the double-side polishing machine can be used for both the substrates for double-side magnetic recording and the substrates for one-side magnetic recording and therefore it is possible to enhance the production efficiency of the magnetic disk substrates.

In the magnetic disk substrate manufacturing method according to the above-aspects of this invention, it is preferable that the disk-shaped substrates are glass substrates.

According to this invention, it is possible to provide a magnetic disk substrate manufacturing method capable of efficiently processing a substrate for a magnetic disk having a magnetic layer only on its one side.

### BRIEF DESCRIPTION OF THE DRAWINGS

FIG. 1 is a diagram showing a schematic structure of a polishing machine for use in a magnetic disk substrate manufacturing method according to an embodiment of this invention;

FIG. 2 is an exemplary diagram showing lower surface plate one-side polishing in the magnetic disk substrate manufacturing method according to the embodiment of this invention;

FIG. 3 is an exemplary diagram showing upper surface plate one-side polishing in the magnetic disk substrate manufacturing method according to the embodiment of this invention; and

FIG. 4 is an exemplary diagram showing upper-lower surface plate simultaneous one-side polishing in the magnetic disk substrate manufacturing method according to the embodiment of this invention.

### DETAILED DESCRIPTION OF EXEMPLARY EMBODIMENTS

Hereinbelow, an exemplary embodiment of this invention will be described in detail with reference to the accompanying drawings.

According to a magnetic disk substrate manufacturing method of this invention, disk-shaped substrates are polished by a polishing machine in a state where a carrier holding the disk-shaped substrates is placed with a plate-like member being disposed on the non-polishing main surface side of the disk-shaped substrates or disk-shaped substrates are polished by a polishing machine in a state where carriers each holding the disk-shaped substrates are respectively placed on both sides of a plate-like member so that the plate-like member is disposed on the non-polishing main surface sides of the disk-shaped substrates held in the carriers.

As a material of the magnetic disk substrates, use can be made of an aluminosilicate glass, a sodalime glass, a borosilicate glass, or the like. Particularly, the aluminosilicate glass can be preferably used because it can be chemically strengthened and it can provide the magnetic disk substrates excellent in flatness of main surfaces thereof and in substrate strength. Alternatively, use can be made of, for example, aluminum as a material of the magnetic disk substrates. Accordingly, the magnetic disk substrate manufacturing method of this invention is applicable not only to the glass substrates but also to various other types of magnetic disk substrates.

The magnetic disk substrate manufacturing method includes processes such as Material Processing Process and First Lapping Process; End Portion Shaping Process (coring process for forming a hole and chamfering process for forming chamfered faces at end portions (outer peripheral end portion and inner peripheral end portion) (chamfered face forming process)); Second Lapping Process; End Face Polishing Process (outer peripheral end portion and inner peripheral end portion); Main Surface Polishing Process (first and second polishing processes); and Chemical Strengthening Process (particularly in the case of glass substrates).

Hereinbelow, the respective processes of the magnetic disk substrate manufacturing method will be described. Herein, a description will be given of the case where magnetic disk substrates are glass substrates.

### (1) Material Processing Process and First Lapping Process

First, in the material processing process, a glass blank, which will be a glass substrate, can be manufactured by a known manufacturing method such as a press method, a float method, a downdraw method, a redraw method, or a fusion method using, for example, a molten glass as a material. If the press method is used among these methods, a plate-like glass can be manufactured at low cost.

In the first lapping process, lapping is applied to both main surfaces of the plate-like glass, thereby obtaining a disk-shaped glass substrate. The lapping can be carried out by using a double-side lapping machine employing a planetary gear mechanism with the use of alumina-based free abrasive particles. Specifically, the lapping is carried out by pressing lapping surface plates onto both main surfaces of the plate-like glass from the upper and lower sides, supplying a grinding fluid containing the free abrasive particles onto the main surfaces of the plate-like glass, and relatively moving them to each other. By this lapping, the glass substrate having flat main surfaces can be obtained.

(2) End Portion Shaping Process (coring process for forming a hole and chamfering process for forming chamfered faces at end portions (outer peripheral end portion and inner peripheral end portion) (chamfered face forming process))

In the coring process, using, for example, a cylindrical diamond drill, an inner hole is formed at a central portion of the glass substrate, thereby obtaining an annular glass substrate. In the chamfering process, grinding is applied to an inner peripheral end face and an outer peripheral end face by using diamond grindstones, thereby carrying out predetermined chamfering to form chamfered faces.

### (3) Second Lapping Process

In the second lapping process, second lapping is applied to both main surfaces of the obtained glass substrate in the same manner as in the first lapping process. By performing this second lapping process, minute irregularities, surface damages, cracks, and the like formed on the main surfaces of the glass substrate in the previous processes are removed and the surface roughness thereof is further reduced than that in the first lapping process, so that it becomes possible to complete a subsequent polishing process of the main surfaces of the glass substrate in a short time.

### (4) End Face Polishing Process

In the end face polishing process, the outer peripheral end face and the inner peripheral end face of the glass substrate are mirror-polished by a brush polishing method. In this event, as polishing abrasive particles, use can be made of, for example, a slurry (free abrasive particles) containing cerium oxide abrasive particles. By this end face polishing process, contaminants, damages, cracks, and the like on the end faces of the glass substrate are removed so that the end faces of the glass substrate are finished to a state that can prevent precipitation of sodium or potassium ions that would otherwise cause corrosion.

(5) Main Surface Polishing Process (first polishing process)

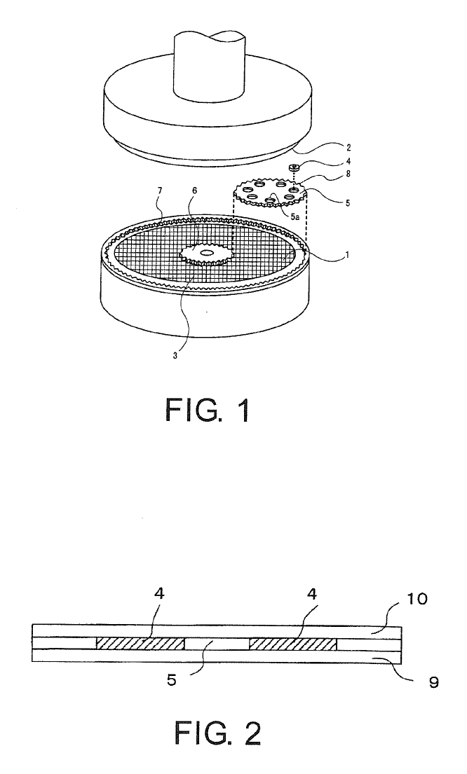

In the main surface polishing process, polishing is carried out by using, for example, a polishing machine employing a planetary gear mechanism, which is shown in FIG. 1. FIG. 1 is a diagram showing a schematic structure of the polishing machine for use in the magnetic disk substrate manufacturing method according to the embodiment of this invention. As shown in FIG. 1, the polishing machine employing the planetary gear mechanism has a pair of upper and lower polishing surface plates 1 and 2. These polishing surface plates 1 and 2 are each formed in a flat plate shape. On a surface of each polishing surface plate, a plurality of grooves 3 are formed in a lattice shape for supplying a polishing agent. Cerium oxide abrasive particles can be used as the polishing agent. Further, a soft-polisher (suede) polishing pad is attached to the surface of each polishing surface plate.

In this double-side polishing machine, a disk-shaped carrier 5 holding glass substrates 4 is placed between the polishing surface plates 1 and 2, then the carrier 5 is pressed between the polishing surface plates 1 and 2, and then the upper polishing surface plate 2 and the lower polishing surface plate 1 are rotated in opposite directions to each other, thereby polishing both main surfaces (upper and lower surfaces) of the glass substrates 4 while supplying the polishing agent. In the planetary gear mechanism, the carrier 5 is placed between a sun gear 6 provided at a central portion of the lower polishing surface plate 1 and an internal gear 7 provided at the outer periphery of the lower polishing surface plate 1. In this event, a tooth portion 8 provided on the circumference of the carrier 5 meshes with the sun gear 6 and the internal gear 7. Therefore, by rotating the upper polishing surface plate 2 and the lower polishing surface plate 1 in opposite directions to each other, the carrier 5 revolves around the sun gear 6, i.e. makes an orbital motion, while rotating on its axis. The glass substrates 4 are held in holes 5a of the carrier 5, respectively.

As polishing methods of this invention using the double-side polishing machine, there are lower surface plate one-side polishing in which a later-described plate-like member 10 is disposed on the upper surfaces of the glass substrates 4 held in the carrier 5 so that only the lower surfaces of the glass substrates 4 are polished by the lower polishing surface plate 1, upper surface plate one-side polishing in which the plate-like member 10 is disposed on the lower surfaces of the glass substrates 4 held in the carrier 5 so that only the upper surfaces of the glass substrates 4 are polished by the upper polishing surface plate 2, and upper-lower surface plate simultaneous one-side polishing in which two carriers 5 are used, an upper surface of the plate-like member 10 is brought into contact with the lower surfaces of the glass substrates 4 held in one of the carriers 5, and a lower surface of the plate-like member 10 is brought into contact with the upper surfaces of the glass substrates 4 held in the other carrier 5 so that only the upper surfaces of the glass substrates 4 held in the one of the carriers 5 are polished by the upper polishing surface plate 2 and only the lower surfaces of the glass substrates 4 held in the other carrier 5 are polished by the lower polishing surface plate 1.

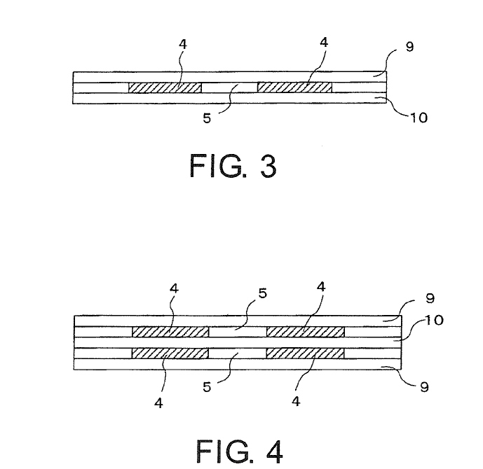

Hereinbelow, the respective polishing methods will be described in detail with reference to FIGS. 2 to 4. FIG. 2 is an exemplary diagram showing the lower surface plate one-side polishing, FIG. 3 is an exemplary diagram showing the upper surface plate one-side polishing, and FIG. 4 is an exemplary diagram showing the upper-lower surface plate simultaneous one-side polishing.

(1. Lower Surface Plate One-Side Polishing)

As shown in FIG. 2, in the lower surface plate one-side polishing, the carrier 5 is placed so that the lower surfaces of the glass substrates 4 are brought into contact with a polishing pad 9 on the lower polishing surface plate 1. Then, the plate-like member 10 is placed on the carrier 5 on its upper side. In this event, the main surfaces of the glass substrates 4 in contact with the polishing pad 9 are main surfaces (recording surfaces) to be polished, while the main surfaces of the glass substrates 4 in contact with the plate-like member 10 are main surfaces (non-recording surfaces) not to be polished. By carrying out the polishing in this state, only the lower surfaces of the glass substrates 4 are polished.

When polishing the glass substrates 4, the glass substrates 4 are brought into tight contact between the polishing surface plates 1 and 2 and the carrier 5 is brought into mesh with the sun gear 6 and the internal gear 7 and is pressed between the polishing surface plates 1 and 2. Then, by rotating the polishing surface plates 1 and 2 in opposite directions to each other while supplying the polishing agent between the polishing pad 9 and the lower surfaces, i.e. the surfaces to be polished, of the glass substrates 4, the carrier 5 makes an orbital motion while rotating on its axis on the lower polishing surface plate 1 so that only the lower surfaces of the glass substrates 4 are polished. That is, in the lower surface plate one-side polishing, the polishing agent is supplied to the lower surfaces of the glass substrates 4.

A material of the plate-like member 10 is not particularly limited as long as it can protect the upper surfaces of the glass substrates 4 from a polishing pad 9 attached to the upper polishing surface plate 2. Various materials such as epoxy glass and SUS (stainless steel) can be used. The thickness or shape of the plate-like member 10 is also not particularly limited, but in terms of uniformly polishing the glass substrates 4, the plate-like member 10 is preferably flat.

(2. Upper Surface Plate One-Side Polishing)

As shown in FIG. 3, in the upper surface plate one-side polishing, the carrier 5 is placed so that the upper surfaces of the glass substrates 4 are brought into contact with the polishing pad 9 on the upper polishing surface plate 2. Then, the plate-like member 10 is placed on the carrier 5 on its lower side. In this event, the main surfaces of the glass substrates 4 in contact with the polishing pad 9 are main surfaces (recording surfaces) to be polished, while the main surfaces of the glass substrates 4 in contact with the plate-like member 10 are main surfaces (non-recording surfaces) not to be polished. By carrying out the polishing in this state, only the upper surfaces of the glass substrates 4 are polished.

When polishing the glass substrates 4, the glass substrates 4 are brought into tight contact between the polishing surface plates 1 and 2 and the carrier 5 is brought into mesh with the sun gear 6 and the internal gear 7 and is pressed between the polishing surface plates 1 and 2. Then, by rotating the polishing surface plates 1 and 2 in opposite directions to each other while supplying the polishing agent between the polishing pad 9 and the upper surfaces, i.e. the surfaces to be polished, of the glass substrates 4, the carrier 5 makes an orbital motion while rotating on its axis on the upper polishing surface plate 2 so that only the upper surfaces of the glass substrates 4 are polished. That is, in the upper surface plate one-side polishing, the polishing agent is supplied to the upper surfaces of the glass substrates 4.

(3. Upper-Lower Surface Plate Simultaneous One-Side Polishing)

As shown in FIG. 4, in the upper-lower surface plate simultaneous one-side polishing, one of the carriers 5 is placed so that the upper surfaces of the glass substrates 4 are brought into contact with the polishing pad 9 on the upper polishing surface plate 2 and the other carrier 5 is placed so that the lower surfaces of the glass substrates 4 are brought into contact with the polishing pad 9 on the lower polishing surface plate 1. Then, the plate-like member 10 is placed between the two carriers 5. In this event, the main surfaces of the glass substrates 4 in contact with the polishing pads 9, respectively, are main surfaces (recording surfaces) to be polished, while the main surfaces of the glass substrates 4 in contact with the plate-like member 10 are main surfaces (non-recording surfaces) not to be polished. By carrying out the polishing in this state, only the upper surfaces are polished for the glass substrates 4 held in the upper carrier 5, while only the lower surfaces are polished for the glass substrates 4 held in the lower carrier 5.

When polishing the glass substrates 4, the glass substrates 4 are brought into tight contact between the polishing surface plates 1 and 2 and the carriers 5 are brought into mesh with the sun gear 6 and the internal gear 7 and are pressed between the polishing surface plates 1 and 2. Then, by rotating the polishing surface plates 1 and 2 in opposite directions to each other while supplying the polishing agent between the polishing pads 9 and the polishing surfaces, i.e. the surfaces to be polished, of the glass substrates 4, the carriers 5 make an orbital motion while rotating on their axes on the polishing surface plates 1 and 2 so that only one of the main surfaces of each of the glass substrates 4 is polished. That is, in the upper-lower surface plate simultaneous one-side polishing, the polishing agent is supplied to the upper surfaces of the glass substrates 4 and the lower surfaces of the glass substrates 4.

In this embodiment, using the polishing machine configured as described above, only one of the main surfaces of each glass substrate can be polished. In the case of, for example, forming a magnetic recording layer only on one side of each glass substrate, polishing can be carried out while protecting the other main surface which requires no polishing. Particularly, in the case of the upper-lower surface plate simultaneous one-side polishing, even when polishing only one of main surfaces of each glass substrate, one-side polishing of the glass substrates can be carried out by using both the upper and lower polishing pads in the polishing machine and thus the production efficiency can be made twice.

Further, according to this embodiment, not only the double-side lapping machine used in the lapping processes can also be used as the polishing machine, but also both double-side polishing and one-side polishing can be carried out by the use of the double-side lapping machine. Therefore, in the manufacturing processes of glass substrates, the products requiring only one-side polishing and the products requiring double-side polishing can both be manufactured in a single production line so that the productivity of the glass substrates can be improved.

(6) Main Surface Polishing Process (final polishing process)

Then, the second polishing process is carried out as a final polishing process. The second polishing process aims to finish only one of both main surfaces, which will serve as a recording surface, of each glass substrate into a mirror surface. In the second polishing process, the main surfaces of the glass substrates are mirror-polished using the double-side polishing machine having the planetary gear mechanism with the use of a soft resin foam polisher in the same manner as described above. As a slurry, use can be made of cerium oxide abrasive particles, colloidal silica, or the like finer than the cerium oxide abrasive particles used in the first polishing process.

The non-recording surface of each glass substrate does not require a roughness as low as that of the recording surface, but preferably has a roughness low enough to prevent the elution of a component (e.g. alkali metal) forming the glass substrate. For such a roughness adjustment of the non-recording surface, it is preferable to polish both main surfaces as in the conventional manner in the first polishing process and to polish only one of both main surfaces, which will be a recording surface, according to the above-mentioned method in the second polishing process.

Herein, the roughness low enough to prevent the elution of the component forming the glass substrate is such that the arithmetic mean roughness, measured by an atomic force microscope (AFM) with a resolution of 256×256 pixels per 2 μm×2 μm square, of the main surface of the glass substrate is preferably 0.005 μm or less.

### (7) Chemical Strengthening Process

In the chemical strengthening process, chemical strengthening is applied to the glass substrates having been subjected to the above-mentioned lapping processes and polishing processes. As a chemical strengthening solution for use in the chemical strengthening, use can be made of, for example, a mixed solution of potassium nitrate (60%) and sodium nitrate (40%). The chemical strengthening is carried out by heating the chemical strengthening solution to 300° C. to 400° C., preheating the cleaned glass substrates to 200° C. to 300° C., and immersing the glass substrates in the chemical strengthening solution for 3 hours to 4 hours. In order to chemically strengthen the entire surfaces of the glass substrates, the immersion is preferably carried out in the state where the glass substrates are placed in a holder so as to be held at their end faces.

By carrying out the immersion in the chemical strengthening solution as described above, lithium ions and sodium ions in surface layers of the glass substrates are replaced by sodium ions and potassium ions having relatively large ionic radii in the chemical strengthening solution, respectively, so that the glass substrates are strengthened.

As described above, according to this embodiment, since only one of the main surfaces of each magnetic disk substrate can be polished even by using the double-side polishing machine, the substrates for one-side magnetic recording can be efficiently produced. Further, in the manufacture of the magnetic disk substrates, the double-side polishing machine can be used for both the substrates for double-side magnetic recording and the substrates for one-side magnetic recording and therefore it is possible to enhance the production efficiency of the magnetic disk substrates.

This invention is not limited to the above-mentioned embodiment and can be carried out by appropriately changing it. The numerical values, materials, sizes, processing sequences, and so on in the above-mentioned embodiment are only examples and this invention can be carried out by changing them in various ways within a range capable of exhibiting the effect of this invention. Other than that, this invention can be carried out in various ways within a range not departing from the object of this invention.

This invention is applicable to various devices incorporating a HDD, such as personal computers and portable music devices.

What is claimed is:

1. A magnetic disk substrate manufacturing method, comprising:
a main surface polishing step of polishing disk-shaped substrates by the use of a polishing machine having a carrier pressed between a pair of surface plates and adapted to make an orbital motion while rotating on its axis, the carrier holding the disk-shaped substrates,
wherein, in the polishing machine, the carrier is placed in a state where a plate-like member is disposed on one side of main surfaces of the disk-shaped substrate, so that only the other side of the main surfaces of the disk-shaped substrate is polished while allowing the one side of the main surfaces of the disk-shaped substrates to be a non-polishing main surface.

2. The magnetic disk substrate manufacturing method according to claim 1, wherein the disk-shaped substrates are glass substrates.

3. A magnetic disk substrate manufacturing method, comprising:
a main surface polishing step of polishing disk-shaped substrates by the use of a polishing machine having carriers pressed between a pair of surface plates and adapted to make an orbital motion while rotating on their axes, the carriers holding the disk-shaped substrates,
wherein, in the polishing machine, in a state where the carriers are respectively placed on both sides of a plate-like member so that the plate-like member is disposed on one side of main surfaces of the disk-shaped substrate held in one of the carriers and on one side of main surfaces of the disk-shaped substrate held in the other carrier, only the other sides of the main surfaces of the disk-shaped substrates are polished while allowing one sides of the main surfaces of the disk-shaped substrates held in the carriers to be a non-polishing main surface.

4. The magnetic disk substrate manufacturing method according to claim 3, wherein the disk-shaped substrates are glass substrates.
